(19) United States
(12) Patent Application Publication
(10) Pub. No.: US 2026/0300065 A1
(43) Pub. Date: Oct. 1, 2026

(54) Uncorrectable Error Correction Code (UECC) Marking of L2P Mapping Units

(71) Applicant: Sandisk Technologies, Inc., Milpitas, CA (US)

(72) Inventors: Jing Shi BOOTH, San Jose, CA (US); Karin INBAR, Ramat Hasharon (IL); Michael Micha YONIN, Rehovot (IL); Dhanunjaya Rao GORRLE, Fremont, CA (US)

(73) Assignee: Sandisk Technologies, Inc., Milpitas, CA (US)

(21) Appl. No.: 19/095,176

(22) Filed: Mar. 31, 2025

(51) Int. Cl. G06F 11/07

(52) U.S. Cl. CPC G06F 11/0751; G06F 11/0727; G06F 11/0781

(57) ABSTRACT

Use of a partial L2P mapping scheme improves costs and uncorrectable byte error rates in large sized SSD when mapping granularity is greater than the basic read unit in NAND. In a L2P table, a mega-fixed logic block address (mFFLBA) may map to a cluster of consecutive FMUs, numbered by JBAs. By special marking in the NAND only the jumbo block addresses (JBAs) in the cluster that have an uncorrectable error, the storage device can avoid mark the all the JBAs associated with the mFFLBA as uncorrectable error correction code (UECC). That is, only the UECC JBAs are indicated as corrupt, while the non-UECC JBAs in the cluster are indicated as good and the user data is not lost. As a result, reliability of the storage device is improved by reducing the defective parts per million (DPPM).

### BACKGROUND OF THE DISCLOSURE

### Field of the Disclosure

Embodiments of the present disclosure generally relate to a data storage device for improving uncorrectable byte error rate (UBER) and reducing defective parts per million (DPPM).

### Description of the Related Art

Non-volatile memory is a type of memory that can retrieve stored information even when power is no longer supplied. Flash memory is an example of a non-volatile memory. Storage devices including flash memory, such as a solid state drive (SSD) and a memory card, have been widely used. Storage devices are useful for storing or moving a large amount of data. The storage capacity of storage devices has greatly increased. A storage device may store data using metadata. However, the storage device cannot operate normally when even a small amount of the metadata is corrupted. For these large sized SSDs, storing entire logic-to-physical (L2P) mappings in volatile memory is expensive and unsustainable for future SSD products, and results in higher UBERs.

Thus, there is a need in the art for an improved data storage device using partial L2P cache to improve costs and UBERs, while reducing DPPM.

### SUMMARY OF THE DISCLOSURE

Use of a partial L2P mapping scheme improves costs and uncorrectable byte error rates in large sized SSD when mapping granularity is greater than the basic read unit in NAND. In a L2P table, a mega-fixed logic block address (mFFLBA) may map to a cluster of consecutive FMUs, numbered by JBAs. By special marking in the NAND only the jumbo block addresses (JBAs) in the cluster that have an uncorrectable error, the storage device can avoid mark the all the JBAs associated with the mFFLBA as uncorrectable error correction code (UECC). That is, only the UECC JBAs are indicated as corrupt, while the non-UECC JBAs in the cluster are indicated as good and the user data is not lost. As a result, reliability of the storage device is improved by reducing the defective parts per million (DPPM).

In one embodiment, a data storage device includes a memory device; and a controller coupled to the memory device, wherein the controller is configured to: receive a command from a host device; search a logic-to-physical (L2P) mapping table for a logic block address (LBA) associated with the command, wherein the LBA maps to a plurality of flash management units (FMUs), each FMU of the plurality of FMUs corresponds to a jumbo block address (JBA) of the memory device; detect whether any of a plurality of JBAs corresponding to the plurality of FMUs has an uncorrectable error; and mark metadata associated to each JBA of the plurality of JBAs detected as uncorrectable error code (UECC), wherein the marking indicates which JBAs of the plurality of JBAs are UECC JBAs.

In another embodiment, a data storage device includes a memory device; and a controller coupled to the memory device, wherein the controller is configured to: receive a command from a host device; search a logic-to-physical (L2P) mapping table for a logic block address (LBA) associated with the command, wherein the LBA maps to a plurality of consecutive flash management units (FMUs), each FMU of the plurality of FMUs corresponds to a jumbo block address (JBA) of the memory device; read metadata associated to a plurality of JBAs corresponding to the plurality of FMUs; identify, based on the reading, whether any of the plurality of JBAs are associated with metadata that is marked, wherein a JBA that is associated with metadata that is marked is a marked JBA; and indicate, based on the identifying, all marked JBAs of the plurality of JBAs as corrupt.

In yet another embodiment, a data storage device includes means to store data; and a controller coupled to the means to store data, wherein the controller is configured to: read metadata associated to a plurality of JBAs, wherein metadata is stored in the means to store data; identify, based on the reading, whether any of the plurality of JBAs are associated with metadata that is marked, wherein a JBA that is associated with metadata that is marked is a marked JBA; detect whether any of the plurality of JBAs has an uncorrectable error; mark metadata associated to each JBA of the plurality of JBAs detected as uncorrectable error code (UECC); and indicate, based on the identifying, all marked JBAs of the plurality of JBAs as corrupt.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic block diagram of a NAND flash layout, according to certain embodiments.

FIG. 3 is a schematic block diagram illustrating a memory cell array, according to certain embodiments.

FIG. 4 is a diagram depicting a one-to-one L2P mapping scheme, according to certain embodiments.

FIG. 5 is a diagram depicting a partial L2P mapping scheme, according to certain embodiments.

FIG. 6 is a flowchart illustrating a method using a partial L2P mapping scheme, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Use of a partial L2P mapping scheme improves costs and uncorrectable byte error rates in large sized SSD when mapping granularity is greater than the basic read unit in NAND. In a L2P table, a mega-fixed logic block address (mFFLBA) may map to a cluster of consecutive FMUs, numbered by JBAs. By special marking in the NAND only the jumbo block addresses (JBAs) in the cluster that have an uncorrectable error, the storage device can avoid mark the all the JBAs associated with the mFFLBA as uncorrectable error correction code (UECC). That is, only the UECC JBAs are indicated as corrupt, while the non-UECC JBAs in the cluster are indicated as good and the user data is not lost. As a result, reliability of the storage device is improved by reducing the defective parts per million (DPPM).

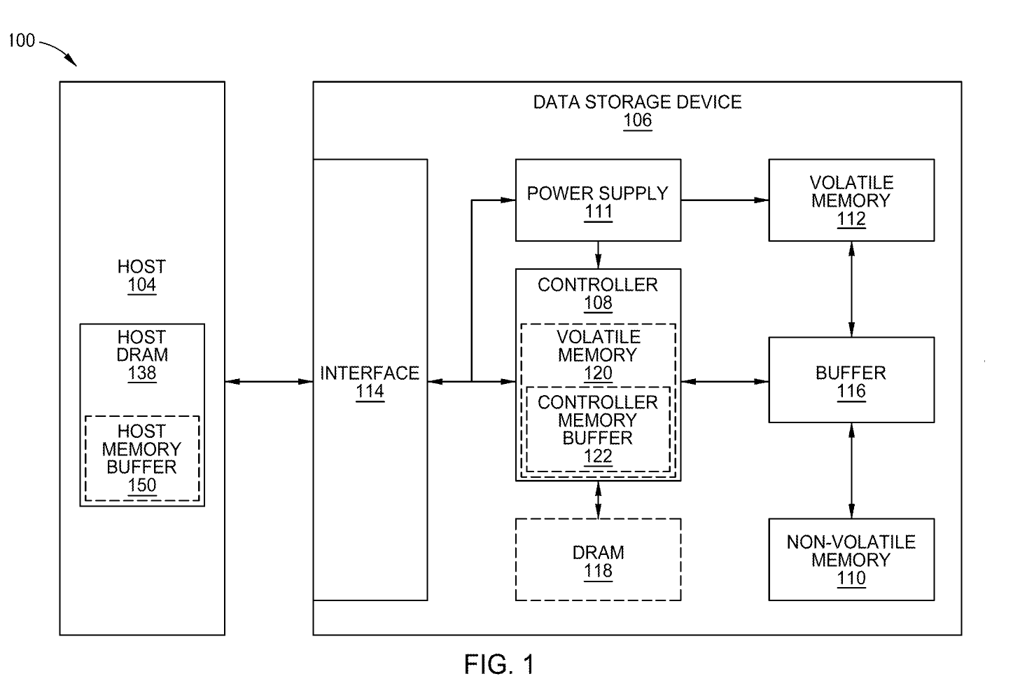

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with non-volatile memory express (NVMe) protocol or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

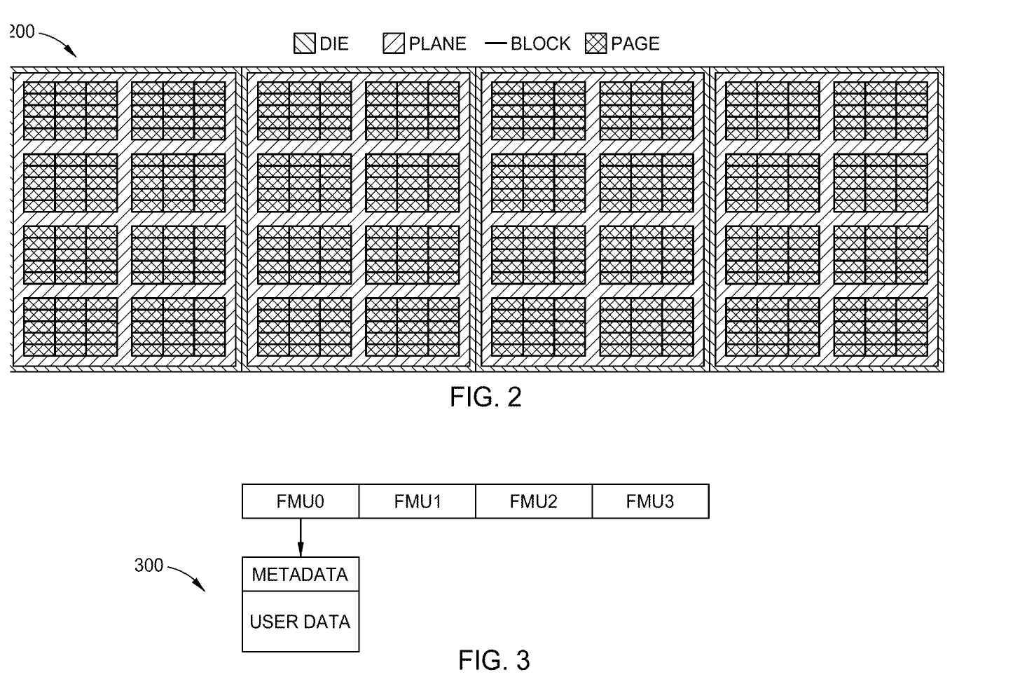

FIG. 2 is a schematic block diagram of a NAND flash layout, according to certain embodiments. In an SSD device, an error correction code (ECC) protected unit in NAND is called a Flash Management Unit (FMU). In one or more embodiments, a FMU size comprises 4KB user data plus X bytes of metadata. In an SSD drive, typically, there is logical-to-physical mapping (L2P) table. The L2P table provides mapping from a logical address, such as fixed logic block address (FFLBA), to a physical address, such as jumbo block address (JBA). In some embodiments, each FFLBA also represents a 4KB user data.

As shown in FIG. 2, NAND flash memory 200 is organized in a hierarchical structure to efficiently store and manage data. A die comprises one or more planes. Several NAND blocks are grouped together to form a plane. A NAND block comprises multiple pages and are the smallest erasable unit in NAND flash memory. A page comprises NAND flash cells that belong to the same block and share the same control gate (word line). A page is the smallest unit that can be programmed or read and, for example.

FIG. 3 is a schematic block diagram illustrating a memory cell array 300, according to certain embodiments. A FMU size comprises 4KB user data plus X bytes of metadata. In some embodiments, memory cell array 300 is a page. Memory cell array 300 comprises four FMUs (i.e., FMU0, FMU1, FMU2, and FMU3). In some embodiments, the size of each FMU is 4KB plus X/4 bytes. The X/4 bytes are used for metadata.

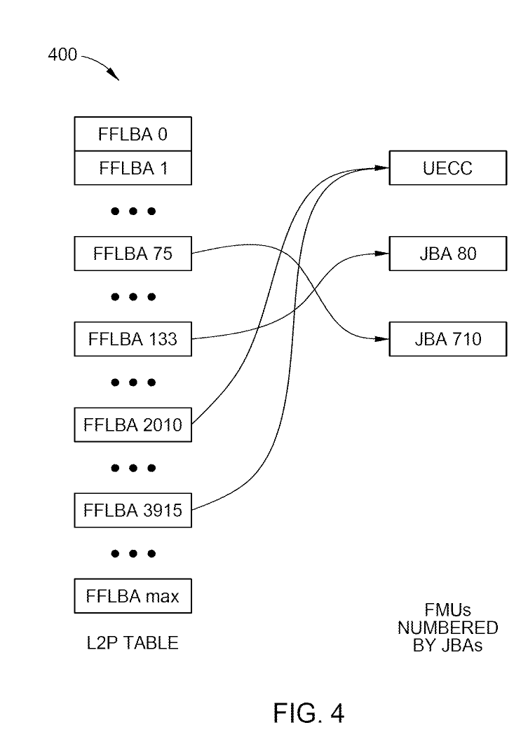

FIG. 4 is a diagram depicting a one-to-one L2P mapping scheme 400, according to certain embodiments. Traditionally, an L2P table entry represents the 4KB of user data. Therefore, the mapping between a FFLBA and a FMU, number by a JBA, is one-to-one mapping. For example, as shown in FIG. 4, FFLBA 75 is mapped to one FMU, i.e., JBA 710. Further, the FFLBA and the corresponding JBA, i.e., the JBA the FFLBA is mapped to, are both 4KB units. However, some FFLBAs of the L2P table are or become unreadable, i.e., the corresponding JBAs have an uncorrectable error and the last written user data is not readable. In this scenario, these FFLBAs (e.g., FFLBA 2010 and 3915) are marked as UECC, so that when a host read comes in to read each of the FFLBAs marked as UECC, by looking at the L2P table alone, the host is informed that the FFLBAs marked as UECC are unreadable. That is, by only looking at the L2P table, the host is informed of the UECC status of each of the JBAs that have an uncorrectable error without having to go to the NAND to read each of the JBAs.

In a one-to-one L2P mapping scheme, e.g., mapping scheme 400, the L2P mapping granularity is the same as the basic read unit (e.g., a JBA) from NAND. That is, the FFLBA and the corresponding JBA, i.e., the JBA the FFLBA is mapped to, are both 4KB units. However, since the L2P table is traditionally stored in DRAM, implementation of a one-to-one L2P mapping scheme in a large sized SSD results in cost-inefficiency because of the resulting large L2P table.

A reason for having large L2P mapping granularity is to address the issue of cost-inefficiency by reducing the large L2P table size. In large granularity L2P mapping, the flash translation layer (FTL) mapping unit size of the L2P table is greater than the JBA unit size the FTL mapping maps to. For example, FTL mapping is done in granularity of 16KB or more (e.g., 32KB, 64KB, and so forth), while granularity of reading from the NAND is 4KB. If a host tries to write in a smaller granularity than the FTL mapping, e.g., 4KB, the storage device will need to apply a read-modify-write operation in order to write back to NAND the entire 32KB (i.e., write back the entire page) to the same location. Traditionally, if a host reads in 4KB and the 4KB reads are UECCs, then the host would go back to the L2P table and mark the entry as UECC. This is so that the next operation will not try to read from the NAND and hit exception handling again.

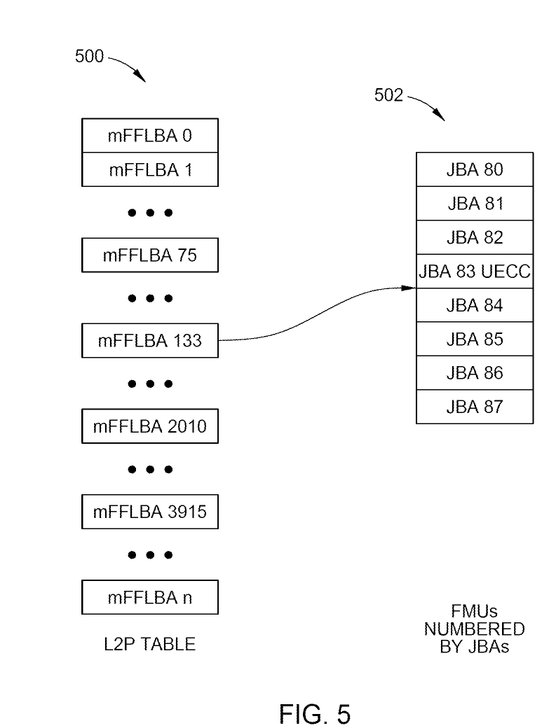

FIG. 5 is a diagram depicting a partial L2P mapping scheme 500, according to certain embodiments. In partial L2P mapping scheme 500, consecutive FMUs are clustered in an 8-to-1 (e.g., 32KB to 4 KB) mapping between FFLBA and JBAs. For example, mega-FFLBA (mFFLBA) 133 contains a cluster 502 of JBAs, i.e., 8 consecutive FMUs numbered by JBAs from JBA 80 to JBA 87. One of the JBAs, e.g. JBA 83, becomes unreadable (UECC), however the storage device does not mark mFFLBA 133 as UECC entirely. Instead, the storage device marks the metadata associated to JBA 83 as UECC. Thus, the rest of the cluster 502 of JBAs (JBAs 80, 81, 82, 84, 85, 86, and 87) are indicated as good and user data is not lost. The number of JBAs in a cluster shown in the exemplary mapping scheme 500 is for exemplary purposes and is not intended to be limiting. It is to be understood that while 8 JBAs (JBA 80 to 87) are depicted in cluster 502, the disclosure is not limited to 8 JBAs. Rather, it is contemplated that more or less 8 JBAs may form a cluster and is based on the mapping granularity.

In an one-to-one L2P mapping scheme, the size of the L2P table is increased, e.g., by 8 bits, each bit indicates whether a mapped LBA is good or UECC. Thus, when a host read comes in, by reading the L2P table from the DRAM alone, the host will know whether the JBA is good or UECC. However, in large sized SSDs, programs that keep an entire L2P mapping in DRAM, such as full L2P mapping (e.g., an one-to-one L2P mapping scheme), are not cost-efficient. Thus, storage devices that have high capacity and high IU that adopt a partial L2P mapping scheme, such as mapping scheme 500, are more cost-efficient. A storage device using a partial L2P mapping scheme may further have a mapping granularity of 32KB or more, and the extra overhead of 8 bits per entry (typically 32 bits to 36 bits).

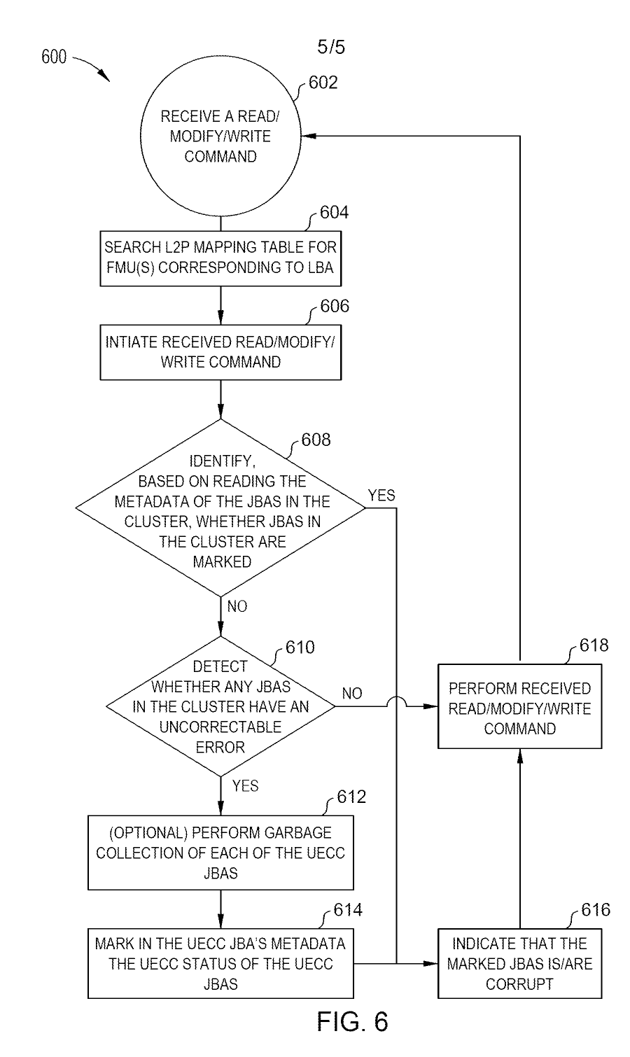

FIG. 6 is a flowchart illustrating a method 600 of partial L2P mapping scheme such as depicted in FIG. 5, according to certain embodiments. At operation 602, a controller (e.g., controller 108 of FIG. 1) of a data storage device (e.g., data storage device 106 of FIG. 1) receives a read, modify, and/or write command from a host device to read, modify, and/or write to a specific LBA. At operation 604, the controller searches the L2P mapping table for FMU(s) corresponding to the LBA, i.e., the cluster (e.g., cluster 502 of FIG. 5) of numbered JBAs that the LBA maps to. At operation 606, the controller initiates the received read, modify, and/or write command. At operation 608, the controller identifies, based on reading the metadata associated with the corresponding JBAs, whether metadata associated with the corresponding JBAs is marked. If the metadata is marked that indicates that the JBA of the cluster associated with the marked metadata has uncorrectable code. Thus, the controller determines whether any of the JBAs of the cluster is corrupt by reading just the metadata of the associated JBAs of the cluster. A JBA that is associated with marked metadata is considered a marked JBA, which is corrupt. If the controller determines that a JBA in the cluster is corrupt, then at operation 616, the controller indicates that the corresponding JBAs are corrupt and that the remaining JBAs of the cluster are not corrupt, before proceeding to operation 618.

If the controller determines that metadata associated with the JBAs of the cluster is not marked, then at operation 610, the controller detects whether from the reading, modifying, and/or writing to the NAND that at least one JBA in the corresponding cluster has an uncorrectable error. If the controller does not detect that any JBAs in the cluster have uncorrectable error, then at operation 618, the controller performs the received read, modify, and/or write command. If the controller detects that at least one JBA in the cluster is an UECC JBA (i.e., has an uncorrectable error), then at optional operation 612, the controller performs an optional garbage collection operation of each of the detected UECC JBAs. In some embodiments, the controller runs the garbage collection and copies the data to a different location. At operation 614, the controller marks the UECC status in metadata of the associated UECC JBA of the cluster. However, the marking does not mark the mFFLBA associated with the UECC JBAs as UECC, only the metadata associated with the UECC JBAs is marked. That is, the metadata of the non-UECC JBA is also unmarked. At operation 616, the controller indicates that any marked JBAs are corrupt (i.e., have uncorrectable errors) and that the remaining non-marked JBAs are not correct, before proceeding to operation 618.

Previously, the storage device kept an indication that the data was lost and was therefore UECC. The legacy SSD marked the corresponding FFLBA entry in the L2P table as UECC. However, when L2P granularity is 16KB or more (e.g., 32KB, 64KB, or more) the penalty is that the entire mFFLBA is marked at UECC, even though the other JBAs might be readable by the NAND. For example, in a L2P granularity of 32KB, the entire 32KB would be marked as UECC, even though the other 28KB might be readable in NAND. Thus, if a single 4KB (i.e., a JBA) is UECC, the controller copies the data, and marks only the failing 4KB as UECC in the NAND itself. However, by specially marking UECC per JBA (e.g., 4KB) in NAND, for example, the metadata associated with the UECC JBAs, only the failing 4KB is marked as UECC in the NAND itself—not the L2P mapping table. This way, the next time the cluster of FMUs is accessed by the host, only the UECC JBAs in the cluster will be indicated instead of the whole cluster itself. The controller will indicate that the data of the UECC JBA is corrupt to the host, but that the other good parts (i.e., the other non-UECC JBAs in the cluster) can be read normally. In some embodiments, the controller performs an internal read/modify/write operation, to write back the failing 4KB with the UECC indication.

For large sized SSD, method 600 using a partial L2P mapping scheme (as depicted in FIG. 5) improves reliability and reduces DPPM if a FMU runs into an unrecoverable error. For example, if a typical UECC is local to a plane boundary, and each plane is 16KB, and an IU is 32KB, and data layout is such that a 32 KB typical spans 2 plane pages, then method 600 potentially reduces UBER by 50% in comparison to an one-to-one mapping scheme.

In some embodiments, the storage device supports automation of the host-read path in hardware, i.e., firmware (e.g., the controller) looks up the location of the data in NAND and generates descriptors to the hardware components in order to read the data from the NAND. In such a system, the UECC indication in the header (e.g., the metadata) needs to be parsed by hardware, so that hardware may raise an error in case of UECC marking. In some embodiments, UECC marking may also be used when copying data in a low-lever layer, in which the LBA is not known and the L2P mapping is not impacted by the copy operation. However, this scenario is generally irrelevant in enterprise-level systems.

By implementing a partial L2P mapping scheme in large sized SSD, the UBER in cases where the IU size is large (e.g., 16KB or more) and write interleaving is such that a single data unit (matching L2P unit size) will typically span multiple plans. If IU is 32KB, the UBER is potentially reduced by 50%. If IU is 64KB, then the UBER is potentially reduced by 75%.

In one embodiment, a data storage device includes a memory device; and a controller coupled to the memory device, wherein the controller is configured to: receive a command from a host device; search a logic-to-physical (L2P) mapping table for a logic block address (LBA) associated with the command, wherein the LBA maps to a plurality of flash management units (FMUs), each FMU of the plurality of FMUs corresponds to a jumbo block address (JBA) of the memory device; detect whether any of a plurality of JBAs corresponding to the plurality of FMUs has an uncorrectable error; and mark metadata associated to each JBA of the plurality of JBAs detected as uncorrectable error code (UECC), wherein the marking indicates which JBAs of the plurality of JBAs are UECC JBAs.

The plurality of FMUs are consecutive. A flash translation layer (FTL) mapping unit size of the L2P mapping table is greater than a size of a JBA of the plurality of JBAs. The FTL mapping unit size is greater than or equal to 16KB, and the size of the JBA is 4KB. The FTL mapping unit size is greater than or equal to 32KB, and the size of the JBA is 4KB. The controller is configured to identify, based on reading metadata associated to the plurality of JBAs, whether any of the plurality of JBAs are associated with metadata that is marked; and indicate, based on the identifying, all marked JBAs of the plurality of JBAs as corrupt. The controller is configured to perform a garbage collection operation on at least one UECC JBA of the plurality of JBAs. The garbage collection operation comprises moving user data of the at least one UECC JBA to another location. At least one JBA of the plurality of JBAs has an uncorrectable error.

In another embodiment, a data storage device includes a memory device; and a controller coupled to the memory device, wherein the controller is configured to: receive a command from a host device; search a logic-to-physical (L2P) mapping table for a logic block address (LBA) associated with the command, wherein the LBA maps to a plurality of consecutive flash management units (FMUs), each FMU of the plurality of FMUs corresponds to a jumbo block address (JBA) of the memory device; read metadata associated to a plurality of JBAs corresponding to the plurality of FMUs; identify, based on the reading, whether any of the plurality of JBAs are associated with metadata that is marked, wherein a JBA that is associated with metadata that is marked is a marked JBA; and indicate, based on the identifying, all marked JBAs of the plurality of JBAs as corrupt.

The controller is configured to detect whether any of the plurality of JBAs has an uncorrectable error; and mark metadata associated to each JBA of the plurality of JBAs detected as uncorrectable error code (UECC), wherein the marking indicates which JBAs of the plurality of JBAs are UECC JBAs. A JBA of the plurality of JBAs that does not have uncorrectable error is not marked. The controller is configured to move data of each of the plurality of JBAs detected as having an uncorrectable error to another location. Metadata associated to the plurality of JBAs is stored in the memory device. The L2P mapping table is stored in a second memory device separate and distinct from the memory device. The second memory device is dynamic random access memory (DRAM) or static random access memory (SRAM). A flash translation layer (FTL) mapping unit size of the L2P mapping table is greater than a size of a JBA of the plurality of JBAs, the FTL mapping unit size is greater than or equal to 16KB.

In yet another embodiment, a data storage device includes means to store data; and a controller coupled to the means to store data, wherein the controller is configured to: read metadata associated to a plurality of JBAs, wherein metadata is stored in the means to store data; identify, based on the reading, whether any of the plurality of JBAs are associated with metadata that is marked, wherein a JBA that is associated with metadata that is marked is a marked JBA; detect whether any of the plurality of JBAs has an uncorrectable error; mark metadata associated to each JBA of the plurality of JBAs detected as uncorrectable error code (UECC); and indicate, based on the identifying, all marked JBAs of the plurality of JBAs as corrupt.

A table entry of a logic-to-physical (L2P) mapping table maps to a plurality of consecutive flash management units (FMUs), and each of the plurality of JBAs corresponds to a FMU of the plurality of consecutive FMUs. A first JBA of the plurality of JBAs is located on a different plane of the means to store data than a second JBA of the plurality of JBAs.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
receive a command from a host device;
search a logic-to-physical (L2P) mapping table for a logic block address (LBA) associated with the command, wherein the LBA maps to a plurality of flash management units (FMUs), each FMU of the plurality of FMUs corresponds to a jumbo block address (JBA) of the memory device;
detect whether any of a plurality of JBAs corresponding to the plurality of FMUs has an uncorrectable error; and
mark metadata associated to each JBA of the plurality of JBAs detected as uncorrectable error code (UECC), wherein the marking indicates which JBAs of the plurality of JBAs are UECC JBAs.

2. The data storage device of claim 1, wherein the plurality of FMUs are consecutive.

3. The data storage device of claim 1, wherein a flash translation layer (FTL) mapping unit size of the L2P mapping table is greater than a size of a JBA of the plurality of JBAs.

4. The data storage device of claim 3, wherein the FTL mapping unit size is greater than or equal to 16KB, and the size of the JBA is 4KB.

5. The data storage device of claim 3, wherein the FTL mapping unit size is greater than or equal to 32KB, and the size of the JBA is 4KB.

6. The data storage device of claim 1, wherein the controller is configured to:
identify, based on reading metadata associated to the plurality of JBAs, whether any of the plurality of JBAs are associated with metadata that is marked; and
indicate, based on the identifying, all marked JBAs of the plurality of JBAs as corrupt.

7. The data storage device of claim 1, wherein the controller is configured to perform a garbage collection operation on at least one UECC JBA of the plurality of JBAs.

8. The data storage device of claim 7, wherein the garbage collection operation comprises moving user data of the at least one UECC JBA to another location.

9. The data storage device of claim 1, wherein at least one JBA of the plurality of JBAs has an uncorrectable error.

10. A data storage device, comprising:
a memory device; and
a controller coupled to the memory device, wherein the controller is configured to:
receive a command from a host device;
search a logic-to-physical (L2P) mapping table for a logic block address (LBA) associated with the command, wherein the LBA maps to a plurality of consecutive flash management units (FMUs), each FMU of the plurality of FMUs corresponds to a jumbo block address (JBA) of the memory device;
read metadata associated to a plurality of JBAs corresponding to the plurality of FMUs;
identify, based on the reading, whether any of the plurality of JBAs are associated with metadata that is marked, wherein a JBA that is associated with metadata that is marked is a marked JBA; and
indicate, based on the identifying, all marked JBAs of the plurality of JBAs as corrupt.

11. The data storage of claim 10, wherein the controller is configured to:
detect whether any of the plurality of JBAs has an uncorrectable error; and
mark metadata associated to each JBA of the plurality of JBAs detected as uncorrectable error code (UECC), wherein the marking indicates which JBAs of the plurality of JBAs are UECC JBAs.

12. The data storage of claim 11, wherein a JBA of the plurality of JBAs that does not have uncorrectable error is not marked.

13. The data storage device of claim 11, wherein the controller is configured to move data of each of the plurality of JBAs detected as having an uncorrectable error to another location.

14. The data storage device of claim 10, wherein metadata associated to the plurality of JBAs is stored in the memory device.

15. The data storage device of claim 14, wherein the L2P mapping table is stored in a second memory device separate and distinct from the memory device.

16. The data storage device of claim 15, wherein the second memory device is dynamic random access memory (DRAM) or static random access memory (SRAM).

17. The data storage device of claim 10, wherein a flash translation layer (FTL) mapping unit size of the L2P mapping table is greater than a size of a JBA of the plurality of JBAs, the FTL mapping unit size is greater than or equal to 16KB.

18. A data storage device, comprising:
means to store data; and
a controller coupled to the means to store data, wherein the controller is configured to:
read metadata associated to a plurality of JBAs, wherein metadata is stored in the means to store data;
identify, based on the reading, whether any of the plurality of JBAs are associated with metadata that is marked, wherein a JBA that is associated with metadata that is marked is a marked JBA;
detect whether any of the plurality of JBAs has an uncorrectable error;
mark metadata associated to each JBA of the plurality of JBAs detected as uncorrectable error code (UECC); and
indicate, based on the identifying, all marked JBAs of the plurality of JBAs as corrupt.

19. The data storage device of claim 18, wherein a table entry of a logic-to-physical (L2P) mapping table maps to a plurality of consecutive flash management units (FMUs), and each of the plurality of JBAs corresponds to a FMU of the plurality of consecutive FMUs.

20. The data storage device of claim 18, wherein a first JBA of the plurality of JBAs is located on a different plane of the means to store data than a second JBA of the plurality of JBAs.
